(19) United States
(12) Patent Application Publication
(10) Pub. No.: US 2011/0100326 A1
(43) Pub. Date: May 5, 2011

(54) Engine Control Unit

(75) Inventors: Yoshiyuki Yoshida, Hitachi (JP); Atsushi Komuro, Hitachinaka (JP)

(73) Assignee: Hitachi Automotive Systems, Ltd., Hitachinaka-shi (JP)

(21) Appl. No.: 12/857,170

(22) Filed: Aug. 16, 2010

(30) Foreign Application Priority Data
Oct. 30, 2009 (JP) 2009-250717

(51) Int. Cl. F02D 9/08; F02N 11/08

(52) U.S. Cl. 123/337; 123/179.4

(57) ABSTRACT

Provided is an engine control unit which is capable of determining whether or not a sudden change in ETC characteristic has occurred, timely learning the ETC characteristic, and thus suppressing excessive racing of an engine and enhancing torque realizing accuracy thereof, at a time other than the opportunity of a regular air quantity learning in a vehicle having no idle state or a less frequent opportunity of the idle state. The engine control unit performs automatic stop control and automatic starting control of an engine and includes: a characteristic storage means which stores therein a characteristic of an air flow rate with respect to a valve opening degree of an electronic throttle control valve; a characteristic change determination means 405b which determines at a time of the automatic stop control that the characteristic of the air flow rate has changed in a direction in which the air flow rate increases with respect to the valve opening degree; a characteristic learning means 405c which corrects the characteristic of the air flow rate on the basis of a result of the determination, to thereby learn the characteristic of the air flow rate; and an electronic throttle control valve control means 407 which controls, on the basis of the learned characteristic of the air flow rate, the valve opening degree of the electronic throttle control valve so that a detected air flow rate becomes a target air flow rate.

### BACKGROUND OF THE INVENTION

1. Field of the Invention

The present invention relates to an engine control unit which performs the automatic stop control and automatic starting control of an engine, and more particularly, to an engine control unit capable of reducing the deterioration in fuel consumption and driving performance.

2. Background Art

Up to now, for the purpose of enhancing the fuel consumption performance of an engine and enhancing the emission quality performance thereof, a vehicle including a control unit with an idle stop function (including a control unit which performs idle stop control) has been put into practical use. In the idle stop function, when the vehicle stops to wait for a traffic light to change, the engine is temporarily automatically stopped on the basis of the operation state of the vehicle, and after that, the engine is automatically restarted by a driver's operation on an accelerator or the like.

In addition, similarly in a hybrid vehicle which is driven by a motor and an engine, the automatic stop control of the engine is performed. Specifically, during the running of the vehicle, when a demanded driving force (demanded driving torque) which is demanded of the vehicle by a driver is equal to or smaller than a predetermined value and a power-generating operation for battery charging is not necessary, the engine which has been operating as a driving force source until then is automatically stopped. After that, when the demanded driving force by the driver becomes larger than the predetermined value (for example, becomes larger than a motor generated torque) or when it is judged that the battery charging is necessary, it is generally performed to give a rotating force to a rotating shaft of the engine to thereby automatically restart the engine.

In conventional vehicles, even in a scene where the driver does not operate an accelerator, the idle operation of the engine is continued. However, the hybrid vehicle and the vehicle with the idle stop function as described above do not execute an unnecessary idle operation owing to the enhanced fuel consumption performance and the enhanced emission quality performance.

Here, the driving force (engine torque) generated by an engine is mainly decided according to an intake air quantity which is sucked into the engine. Specifically, an engine control unit adjusts (controls) the valve opening degree of an electronic throttle control valve (hereinafter, referred to as ETC) which is disposed in an intake pipe of the engine, in accordance with a target engine torque, to thereby control the intake air quantity (air flow rate), that is, an engine generated torque.

Such control is performed as described below. Specifically, the engine control unit calculates the intake air quantity in order to realize the target engine torque according to the demanded driving force. Meanwhile, the engine control unit stores therein in advance an ETC characteristic indicating the relation between the ETC opening degree and the intake air quantity (a characteristic of the air flow rate with respect to the valve opening degree of the electronic throttle control valve). After that, on the basis of the calculated intake air quantity, the engine control unit decides (calculates) the ETC opening degree (valve opening degree) by using the stored ETC characteristic as a reference. In order to realize the decided valve opening degree, the control unit inputs an electrical signal to the ETC, and controls (adjusts) the ETC opening degree.

Here, the ETC characteristic changes due to an instrumental error and degradation with time. Therefore, the engine control unit is adapted to learn the deviation of the stored ETC characteristic (the deviation of the relation between the ETC opening degree and the intake air quantity) on the basis of the correlation between the intake air quantity detected by an airflow sensor provided to the engine and the intake air quantity with respect to the ETC opening degree, which is obtained from the ETC characteristic (hereinafter, referred to as air quantity learning).

In the transient state where an engine speed and an engine load change, the intake air quantity detected by the airflow sensor has a phase delay due to an intake pipe volume. For this reason, in terms of securing with high accuracy the correlation between the ETC opening degree and the intake air quantity, generally, the air quantity learning is executed in a stable operation state, that is, an idle operation state.

However, as described above, in the vehicle with the idle stop function, basically, an idle operation point does not exist, and hence the opportunity of the air quantity learning cannot be secured. On the other hand, each time an ignition switch is turned on (each TRIP), if the idle stop function is prohibited until the air quantity learning is completed, this may lead to the deterioration in fuel consumption performance and emission quality performance. In view of this, JP Patent Publication (Kokai) No. 2005-325794A proposes that, instead of executing the air quantity learning for each TRIP, the opportunity of the air quantity learning is given in accordance with the number of times of execution of the idle stop function, the period of time thereof, the number of times of warm-up operation and start, and the like, to thereby reduce the deterioration in fuel consumption performance and emission quality performance.

### SUMMARY OF THE INVENTION

Incidentally, first, in the air quantity learning, the control unit initially corrects fluctuations of the ETC characteristic due to an instrumental error. After that, the control unit uses, as a main age-related change amount, a characteristic change amount (in general, in a direction in which passing air decreases with respect to the ETC opening degree) due to the adhesion of a foreign matter (gumlike deposit) (hereinafter, referred to as deposit adhesion) to an ETC air passage portion, which arises from the mixing-in of a blow-by gas and the like, to thereby correct the ETC characteristic.

Here, it is known that the foreign matter which is deposited and adhered onto the ETC air passage portion irregularly peels off and falls (is removed) due to a change in operation state of the engine, a change in vibrations, a change in environmental temperature, or the like, in other words, deposit peeling-off is known. In the state where an air quantity decrease amount due to the deposit adhesion is corrected by a learning value toward an increase side (that is, toward the side on which the valve opening degree is made higher than its initial state), if the deposit peeling-off has occurred, the air quantity of a part of the learning value corresponding to the deposit adhesion is excessive. As a result, this causes the excessive racing of the engine and the reduction in torque realizing accuracy thereof.

As described above, in the case as the deposit adhesion where the ETC characteristic changes with time, if the air quantity learning is regularly executed, the control unit can sufficiently handle this change because the ETC characteristic changes gradually. On the other hand, in the case as the deposit peeling-off where the ETC characteristic largely changes at the same timing and in an irregular manner compared with the deposit adhesion, even if the air quantity learning is regularly executed, it is difficult for the control unit to correspondingly handle the change in ETC characteristic. As a result, until the air quantity learning is regularly executed for the next time, the learned ETC characteristic is in an unmatched state, and the excessive racing state of the engine and the reduction state of the torque realizing accuracy thereof are held, which may lead to a problem that the fuel consumption performance, the emission quality performance, and the driving performance are impaired.

The present invention has been made in view of the engine performance deterioration due to an irregularly-occurring ETC characteristic change, and therefore has an object to provide an engine control unit which is capable of determining whether or not a sudden change in ETC characteristic has occurred, timely learning the ETC characteristic, and thus suppressing the excessive racing of an engine and enhancing the torque realizing accuracy thereof, at a time other than the opportunity of a regular air quantity learning in the vehicle with the idle stop function or the hybrid vehicle having no idle state or a less frequent opportunity of the idle state.

In order to achieve the above-mentioned object, the present invention provides an engine control unit which performs automatic stop control and automatic starting control of an engine and includes: an electronic throttle control valve which controls an air flow rate sucked into the engine; air flow rate detection means which detects the sucked air flow rate; and engine speed detection means which detects a speed of the engine, the engine control unit further including: characteristic storage means which stores therein a characteristic of the air flow rate with respect to a valve opening degree of the electronic throttle control valve; characteristic change determination means which determines at a time of the automatic stop control that the characteristic of the air flow rate has changed in a direction in which the air flow rate increases with respect to a predetermined valve opening degree or determines at the time of the automatic stop control that the characteristic of the air flow rate has suddenly changed; characteristic learning means which learning the characteristic of the air flow rate by correcting the characteristic of the air flow rate on the basis of a result of the determination; and electronic throttle control valve control means which controls, on the basis of the learned characteristic of the air flow rate, the valve opening degree of the electronic throttle control valve so that the detected air flow rate becomes a target air flow rate.

A learning value calculated by air quantity learning means is reflected by target ETC opening degree calculation means which calculates an ETC opening degree in accordance with a target torque demanded of the engine, and a desired ETC opening degree, that is, an intake air quantity is controlled.

According to the present invention, in the vehicle having no idle state or a less frequent opportunity of the idle state, it is possible to timely learn the ETC characteristic, and thus suppress the excessive racing of the engine and enhance the torque realizing accuracy thereof, at the time other than the opportunity of the regular air quantity learning.

### BRIEF DESCRIPTION OF THE DRAWINGS

FIG. 1 is an entire configuration diagram of an engine control system including a control device for an in-cylinder injection engine (engine control unit) according to an embodiment of the present invention.

FIG. 2 is a diagram illustrating a main part of the engine control unit.

FIG. 3 is a control block diagram for calculating a target ETC opening degree in the engine control unit according to the present embodiment.

FIG. 4 is a characteristic correlation graph of a target torque, an opening area, and an ETC opening degree.

FIG. 5 is a graph for describing a change in ETC characteristic due to age-related degradation.

FIG. 6 is a diagram for describing states of deposit adhesion due to the age-related degradation shown in FIG. 5, in which (A) illustrates an initial state thereof, (B) illustrates the deposit adhesion (ETC clogged state), and (C) illustrates deposit peeling-off (clogging released state).

FIG. 7 is a diagram illustrating one mode of air quantity learning means according to the present embodiment.

FIG. 8 is a flow chart of the air quantity learning means according to the present embodiment.

FIG. 9 is a time chart showing an engine speed behavior and a change in ISC F/B air quantity in an idle state before the transition to idle stop at the time of the deposit adhesion.

FIG. 10 is a time chart showing the engine speed behavior and the change in ISC F/B air quantity in the idle state before the transition to the idle stop, in the case where the deposit peeling-off has occurred at a given time point during an engine operation.

FIG. 11 is a time chart showing an example of an idle stop operation during turn-on of an ignition switch (during TRIP).

FIG. 12 is a graph showing an example of storage of the ISC F/B air quantity and calculation of a characteristic change determination region at a predetermined timing in each interval.

FIG. 13 is a flow chart of air quantity learning means according to a second embodiment of the present invention.

FIG. 14 is a time chart of ETC characteristic change determination based on the engine speed behavior before the transition to the idle stop with the use of the air quantity learning means according to the second embodiment.

### DETAILED DESCRIPTION OF THE PREFERRED EMBODIMENTS

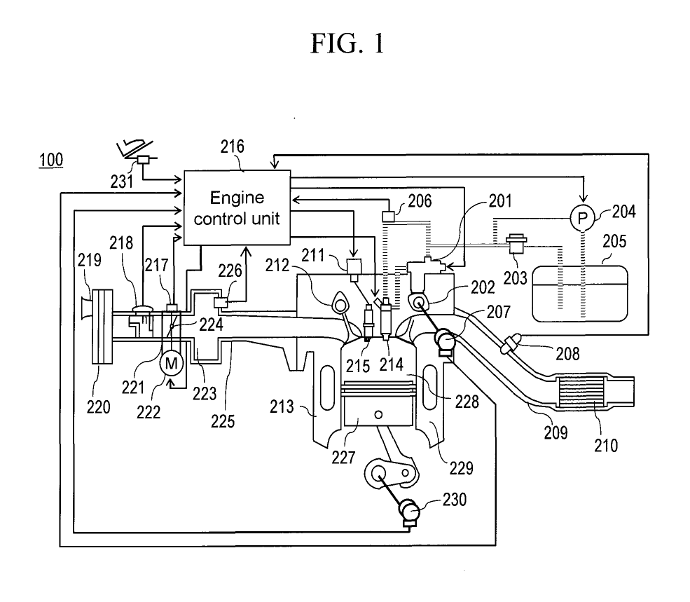

Hereinafter, with reference to FIGS. 1 to 14, embodiments of the present invention are described in detail.

### First Embodiment

FIG. 1 is an entire configuration diagram of an engine control system 100 including a control device for an in-cylinder injection engine (engine control unit) according to the present embodiment.

In the engine control system 100, an intake air introduced to a cylinder 229 is taken in through an inlet port 219 of an air cleaner 220. The taken-in intake air passes through an airflow sensor (air flow rate detection means) 218 which is one of the components of engine operation state measurement means, and an intake air quantity (intake flow rate) is measured by the airflow sensor 218. At the downstream thereof, the intake air passes through a throttle body 221 housing an electronic throttle control valve (ETC) 224 which controls the intake flow rate, and enters a collector 223. The air sucked into the collector 223 is distributed to each intake pipe 225 connected to each cylinder 229 of an engine 213, and then is introduced to a combustion chamber 228 of the cylinder 229.

As described above, a signal representing the intake flow rate is outputted from the airflow sensor 218 to an engine control unit 216 corresponding to the engine control unit. A throttle sensor 217 which detects a valve opening degree of the ETC 224 and is one of the components of the engine operation state measurement means is attached to the throttle body 221, and a signal therefrom is also outputted to the engine control unit 216. The engine control unit 216 calculates a target torque demanded of the engine, outputs a driving signal to a motor 222 attached to the throttle body 221 on the basis of the calculated target torque, controls the valve opening degree of the ETC 224, and as a result thereof, controls the intake air quantity.

On the other hand, a fuel such as gasoline from a fuel tank 205 is primarily pressurized by a fuel pump 204, is adjusted to a given pressure (for example, 0.3 MPa) by a fuel pressure regulator 203, and then is secondarily pressurized by a high-pressure fuel pump 201 to a higher pressure (for example, 5 MPa) to be sent under pressure to a common rail.

The high-pressure fuel is injected from an injector 214 provided to each cylinder 229 to the combustion chamber 228 at a predetermined quantity and at a predetermined timing on the basis of the driving signal from the engine control unit 216. The fuel injected to the combustion chamber 228 is ignited at a spark plug 215 according to an ignition signal to which a high voltage is applied by an ignition coil 211 at the timing controlled similarly by the engine control unit 216.

In addition, a cam angle sensor 207 attached to a cam shaft of an exhaust valve outputs a signal for detecting a phase of the cam shaft to the engine control unit 216. It should be noted that the cam angle sensor may be attached to a cam shaft of an intake valve. In addition, in order to detect the number of revolutions of a crank shaft of the engine (engine speed) and a phase thereof, a crank angle sensor (engine speed detection means) 230 is provided on the crank shaft, and an output of the crank angle sensor is inputted to the engine control unit 216.

Further, an A/F sensor 208 provided at the upstream of a catalyst 210 within an exhaust pipe 209 detects an exhaust gas, and a detection signal thereof is inputted to the engine control unit 216.

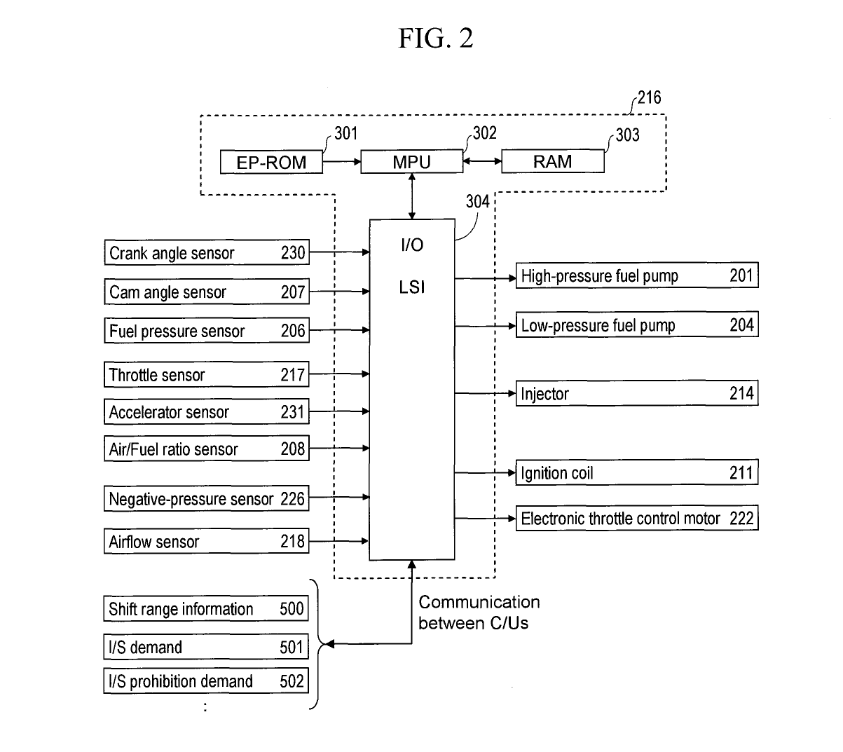

FIG. 2 illustrates a main part of the engine control unit 216. As illustrated in FIG. 2, the engine control unit 216 includes an MPU 302, a ROM 301, a RAM 303, an I/O LSI 304 including an A/D converter, and the like. The engine control unit 216 takes in, as its inputs, signals from various sensors such as the crank angle sensor 230, the cam angle sensor 207, a fuel pressure sensor 206, the throttle sensor 217, an accelerator sensor 231, the air/fuel ratio sensor 208, a negative-pressure sensor 226, and the airflow sensor 218 each of which is one of the components of the engine operation state measurement (detection) means. Further, the engine control unit 216 executes a predetermined calculation process, and outputs various control signals which are determined as a result of the predetermined calculation process. Still further, the engine control unit 216 supplies predetermined control signals to a solenoid of the high-pressure fuel pump 201, the low-pressure fuel pump 204, the injector 214, the ignition coil 211, and the electronic throttle control motor (ETC motor) 222, to thereby execute the fuel injection quantity control, the ignition timing control, the intake air quantity control, and the fuel pressure control using a high-pressure pump.

As described above, the engine is provided with the various analog sensors, and in the engine control, each of the sensors is subjected for use to a signal process such as filtering or masking in accordance with a control target.

In addition, data items of shift range information 500, an idle stop execution (advance notice) demand 501, an idle stop prohibition demand 502, and the like are exchanged through interunit communication such as CAN communication. The shift range information 500 is given by a driver's operation and detected by a control unit other than the engine control unit 216. The idle stop execution (advance notice) demand 501 and the idle stop prohibition demand 502 are transmitted from a control unit which collectively controls an engine, a motor, and a battery in a hybrid vehicle or the like. The idle stop prohibition demand 502 indicates a state where the idle stop control is prohibited as the engine control.

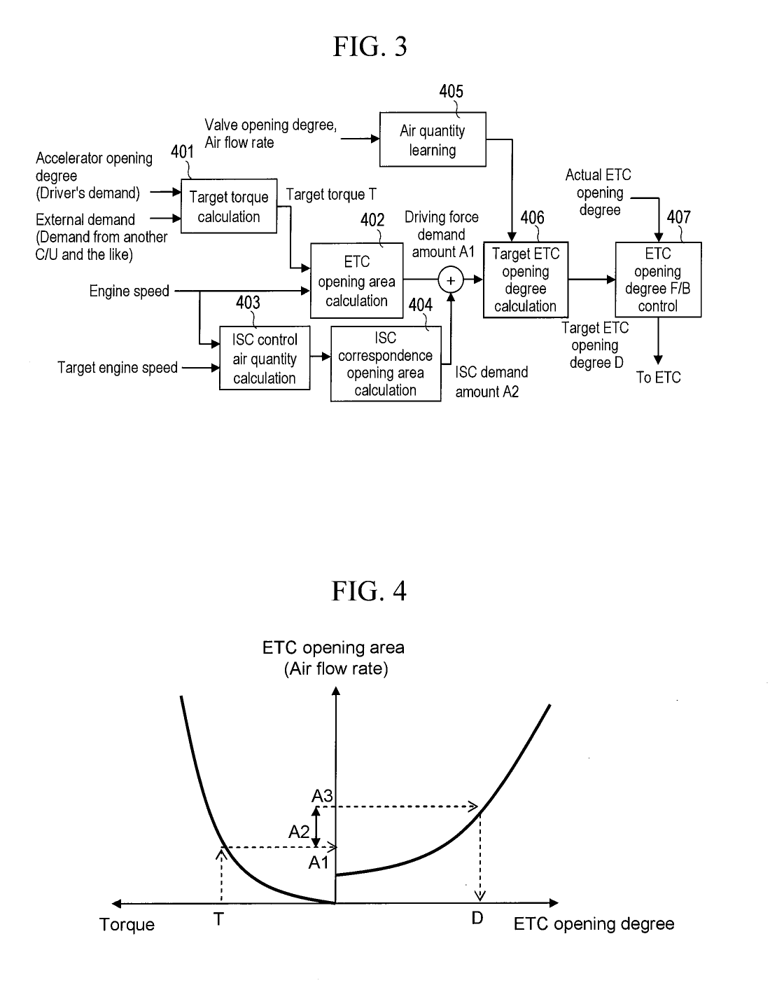

FIG. 3 is a control block diagram for calculating a target ETC opening degree in the engine control unit 216 according to the present embodiment. The engine control unit 216 includes target torque calculation means 401, ETC opening area calculation means 402, ISC control air quantity calculation means 403, ISC correspondence opening area calculation means 404, air quantity learning means 405, target ETC opening degree calculation means 406, and ETC opening degree F/B control means 407.

The target torque calculation means 401 calculates a target torque on the basis of an accelerator opening degree of the accelerator pressed by a driver and an external demand (demand from another C/U) such as the intake air quantity. The ETC opening area calculation means 402 calculates an ETC opening area (a passage area of the intake air quantity) as a driving force demand amount which is uniquely determined from the calculated target torque and the engine speed in accordance with engine characteristics.

On the other hand, in the idle speed control (hereinafter, referred to as ISC), the ISC control air quantity calculation means 403 calculates an ISC air quantity (target air flow rate) on the basis of a target engine speed and an actual engine speed for an engine speed holding amount at the time of the accelerator-off, that is, a so-called idle state, and the ISC correspondence opening area calculation means 404 calculates an ISC correspondence opening area similarly to the calculation of the torque demand amount by the ETC opening area calculation means 402.

An opening area A1 as the driving force demand amount calculated by the ETC opening area calculation means 402 and an ISC correspondence opening area A2 calculated by the ISC correspondence opening area calculation means 404 are added to each other, and the addition result is used as an ETC opening area necessary for a current operation state.

On the other hand, the air quantity learning means 405 stores therein in advance an ETC characteristic which is a correlated characteristic of the air flow rate (opening area) with respect to the valve opening degree of the electronic throttle control valve (characteristic storage means), and learns, from the operation state, the change in ETC characteristic (the correlated characteristic between the opening area and the valve opening degree) which changes with age.

The target ETC opening degree calculation means 406 uses the ETC characteristic (the correlated characteristic between the opening area and the valve opening degree) learned by the air quantity learning means 405 to calculate a target ETC opening degree to be controlled lastly on the basis of the ETC opening area necessary for the current operation state.

The ETC opening degree F/B control means 407 outputs to the ETC a control signal for feedback control of an actual ETC opening degree which is an actual opening degree of the ETC so that the target ETC opening degree calculated by the target ETC opening degree calculation means 406 is realized.

As described above, the target ETC opening degree calculation means 406 and the ETC opening degree F/B control means 407 serve to control the valve opening degree of the electronic throttle control valve on the basis of the characteristic of the learned air flow rate so that the detected air flow rate becomes the target air flow rate.

Here, for example, at the time of the idle operation in automatic stop control such as the idle stop control, the ISC control air quantity calculation means 403 calculates the target air flow rate so that the detected engine speed becomes the target engine speed in the idle operation, and calculates a difference between the target air flow rate and the detected air flow rate as a feedback correction air flow rate (idle speed F/B correction amount (hereinafter, referred to as ISC F/B correction amount)) (feedback correction air flow rate calculation means). It should be noted that the target ETC opening degree calculation means 406 may calculate a valve opening degree amount corresponding to the feedback correction air flow rate, and the ETC opening degree FB control means 407 may control the valve opening degree amount.

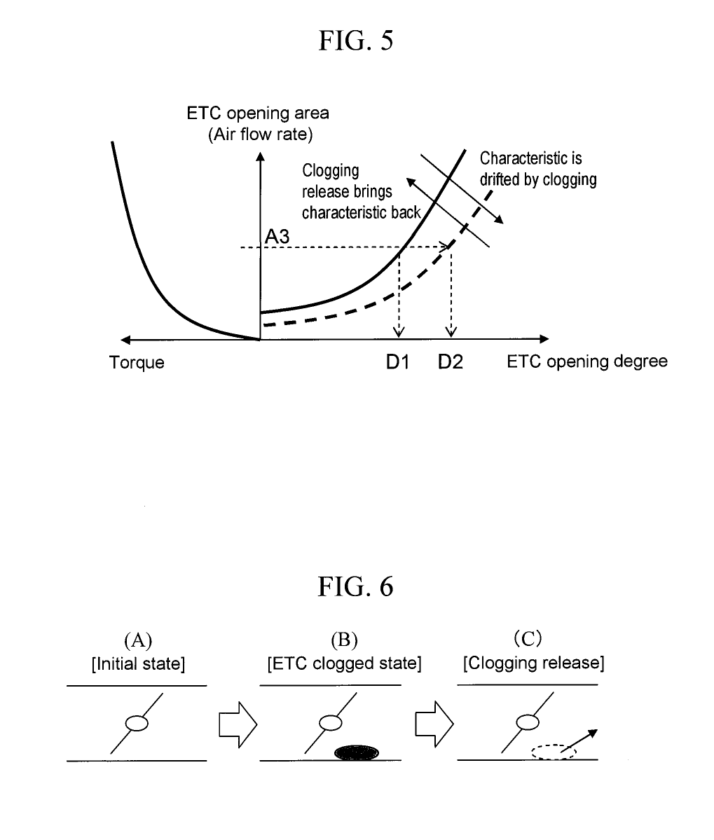

FIG. 4 is a characteristic correlation graph of the target torque, the opening area, and the ETC opening degree. FIG. 5 is a graph for describing a change in ETC characteristic due to age-related degradation. In addition, FIG. 6 is a diagram for describing states of deposit adhesion due to the age-related degradation shown in FIG. 5, in which (A) illustrates an initial state thereof, (B) illustrates the deposit adhesion (ETC clogged state), and (C) illustrates deposit peeling-off (clogging released state).

As shown in FIG. 4, the ETC characteristic which is the correlated characteristic of the air flow rate (opening area) with respect to the valve opening degree of the electronic throttle control valve is stored in advance as an initial characteristic value (characteristic storage means), and the relation between the target torque and the opening area is as shown in the figures. Here, on the basis of a target torque T calculated by the target torque calculation means 401, the ETC opening area calculation means 402 calculates the ETC opening area A1 from the graph shown in FIG. 4. Then, the ISC correspondence opening area (ISC demand amount) A2 calculated by the ISC correspondence opening area calculation means 404 is added to the ETC opening area (driving force demand amount) A1 to calculate a target opening area A3. The target ETC opening degree calculation means 406 calculates a target ETC opening degree D from the ETC characteristic graph shown in FIG. 4.

Here, over the course of operating the engine, as shown in FIG. 5, a characteristic drift occurs due to an age-related change such as the deposit adhesion. The ETC characteristic shown in FIG. 5 is an ETC characteristic which goes into the ETC clogged state (B) illustrated in FIG. 6 from the initial state (A) illustrated in FIG. 6 due to the deposit adhesion or the like.

In this case (in the case of the state (B)), when the target ETC opening degree is calculated from the ETC characteristic stored in advance with respect to the same ETC opening area A, the calculation result is D1. If the ETC is controlled by the target opening degree D1, the intake air quantity ends up being insufficient. Because the actual ETC characteristic has changed in the clogged state due to the deposit adhesion or the like, it is necessary to set an ETC opening degree D2 larger than the ETC opening degree D1 in order to obtain the same intake air quantity.

Therefore, the air quantity learning means 405 corrects this drift amount of the ETC characteristic (corrects the ETC characteristic difference between a solid line and a broken line in FIG. 5 as a learning value), to thereby perform air quantity learning. Specifically, the air quantity learning means 405 uses FIG. 5 to calculate the air flow rate on the basis of the valve opening degree detected by the throttle sensor 217. Then, if the difference between the calculated air flow rate and the air flow rate detected by the airflow sensor 218 becomes equal to or larger than a predetermined value, this means that a characteristic deviation has occurred, and hence the air quantity learning means 405 corrects the ETC characteristic to the valve opening degree corresponding to the air flow rate as indicated by a dotted line in FIG. 5.

Here, though irregularly, the deposit adhesion which causes the ETC clogged state (B) in FIG. 6 sometimes peels off and falls (is removed) depending on the operation state of the engine and environmental conditions, which results in the clogging released state (C). Accordingly, for the air quantity learning value at which the characteristic drift amount due to the deposit adhesion is corrected, it is necessary to cancel the learning value amount which has been built up by the age-related degradation until then so as to approach the initial state (A) by relearning.

In the conventional control unit in which the idle state is regularly provided to execute the air quantity learning, the learning value cancel timing for an irregularly-occurring deposit peeling-off state is the next regular learning timing, which thus causes the excessive racing of the engine due to the excessive air quantity and the reduction in torque realizing accuracy thereof until the next regular learning timing.

In view of the above, in the engine control unit (engine control system) according to the present embodiment, an engine speed behavior and an engine speed control parameter are monitored as described below, to thereby timely detect (determine) the ETC characteristic change (a sudden change in ETC characteristic) due to the irregularly-occurring deposit peeling-off or the like, and the timing of this sudden change is used as a trigger to execute the relearning, which makes it possible to cancel the air quantity learning value which has been built up until then.

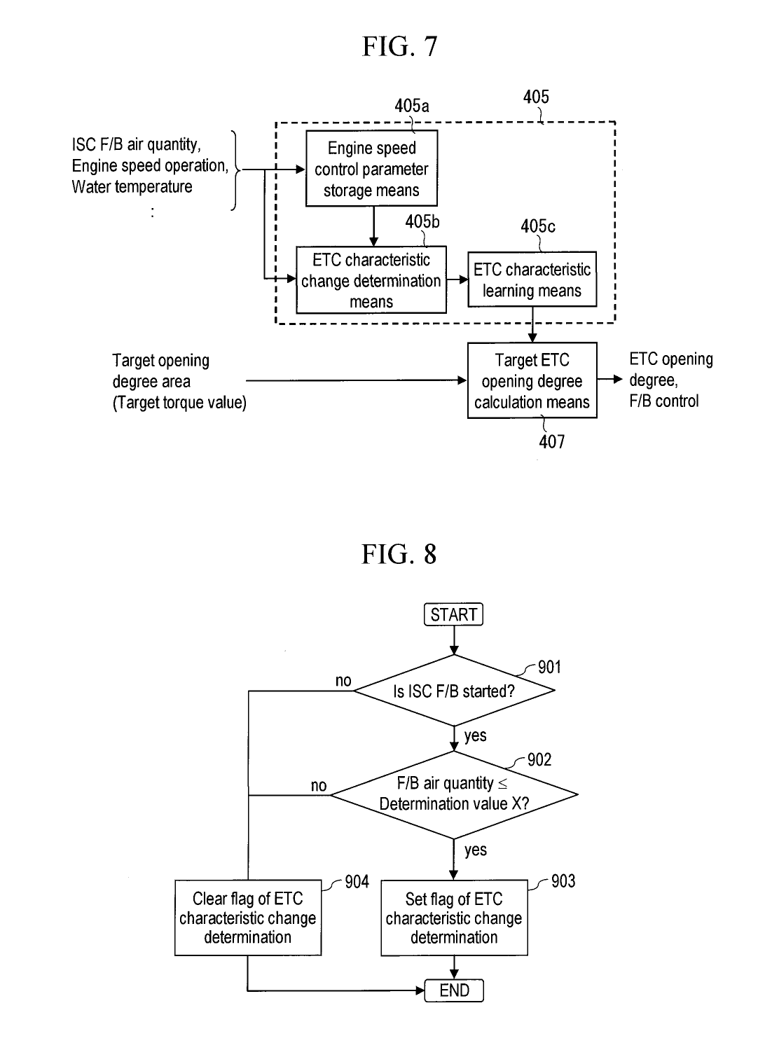

FIG. 7 illustrates one mode of the air quantity learning means 405 according to the present embodiment. The air quantity learning means 405 includes engine speed control parameter storage means 405a, ETC characteristic change determination means 405b, and ETC characteristic learning means 405c.

The engine speed control parameter storage means (history storage means) 405a stores and holds therein the engine speed and the engine speed behavior (an engine speed trace which decreases along with a change in time or a decrease rate of the engine speed) before the transition to an idle stop state, the idle speed F/B correction amount (hereinafter, referred to as ISC F/B correction amount (feedback correction air flow rate)) in an idle operation state before the engine makes the transition to the idle stop state, and the history of the engine control parameter such as a water temperature condition.

The ETC characteristic change determination means 405b determines in the automatic stop control that a characteristic of the air flow rate (ETC characteristic) has changed in a direction in which the air flow rate increases with respect to the valve opening degree. That is, the ETC characteristic change determination means 405b determines that the ETC characteristic has changed (has suddenly changed) due to the deposit peeling-off or the like (has changed in the direction in which the air flow rate increases with respect to the valve opening degree), on the basis of the stored engine speed control parameter, the engine speed and behavior before the transition to the current idle stop, and a change amount of the ISC F/B correction amount (comparison with a predetermined threshold value), and uses this determination as a trigger to demand the air quantity learning (relearning).

The ETC characteristic learning means (characteristic learning means) 405c stores therein the ETC characteristic (characteristic storage means), and performs the air quantity relearning on the basis of the determination result by the ETC characteristic change determination means 405b (when the air quantity learning is demanded) (specifically, as described above, the stored ETC characteristic is corrected).

The target ETC opening degree calculation means 406 uses the ETC characteristic which is the learning value calculated by the ETC characteristic learning means 405c to calculate the valve opening degree of the ETC in accordance with the target torque demanded of the engine (target opening degree area). With this, the target ETC opening degree calculation means 406 can control a desired valve opening degree of the ETC, that is, the intake air quantity.

On the basis of sudden changes of the engine speed before the transition to the idle stop state and the ISC F/B correction amount at the time of the idle operation, the irregularly-occurring deposit peeling-off or the like can be timely determined, and the air quantity relearning can be executed. Accordingly, it becomes possible to resolve the excessive racing of the engine and the reduction in torque realizing accuracy thereof, which would not be resolved otherwise until the opportunity of the air quantity learning to be regularly executed for the next time.

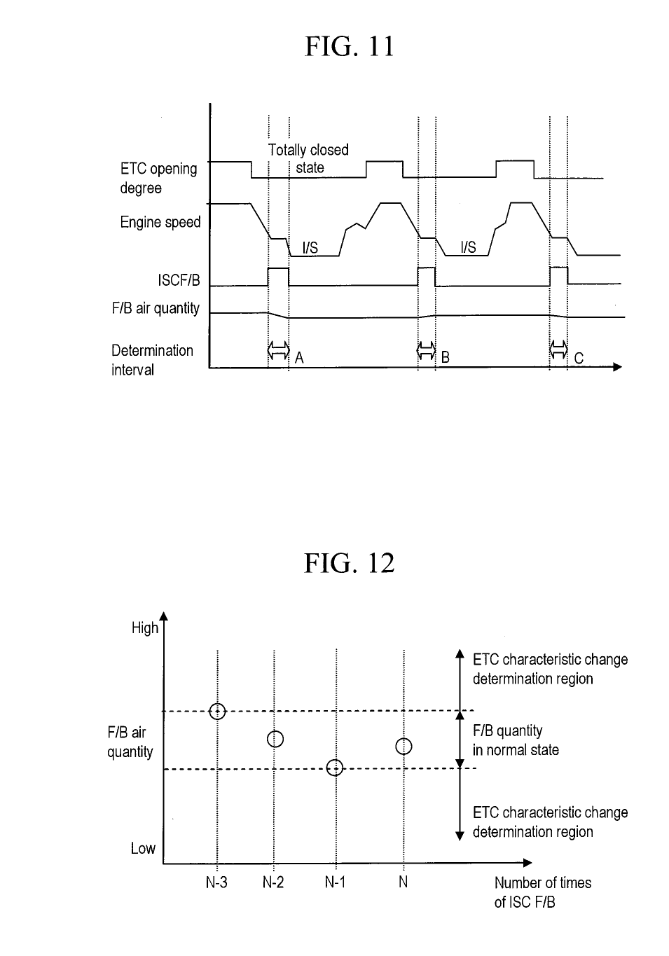

FIG. 8 is a flow chart of the air quantity learning means 405 according to the present embodiment. First, in Step 901, it is determined whether or not the feedback (F/B) control is started in the idle speed control (ISC). In this step, if the ISC F/B control is started, the processing proceeds to Step 902, and it is determined whether or not the feedback correction air flow rate (ISC F/B air quantity) which is the difference between the target air flow rate at this time and the detected air flow rate is equal to or smaller than a predetermined threshold value (determination value X). A value which cannot be obtained in a normal state may be set to the determination value X as a fixed value, or the determination value X may be calculated according to a method as shown in FIGS. 11 and 12 to be described later.

Then, if the feedback control amount (feedback correction air flow rate (F/B air quantity)) is equal to or smaller than the predetermined threshold value (determination value X) (for example, if a sudden change is found in comparison with the history or the like), the processing proceeds to Step 903, it is understood that the change in ETC characteristic such as the deposit peeling-off has occurred (the ETC characteristic has suddenly changed). Then, a flag of the ETC characteristic change is set, and the air quantity relearning is performed. It should be noted that, in the case of the deposit peeling-off, the characteristic of the air flow rate changes in the direction in which the air flow rate increases with respect to the valve opening degree.

On the other hand, if the ISC F/B control is not started or if the feedback control amount (F/B air quantity) is larger than the predetermined threshold value (determination value X), the processing proceeds to Step 904, the flag of the ETC characteristic change is cleared, and the air quantity relearning is not performed.

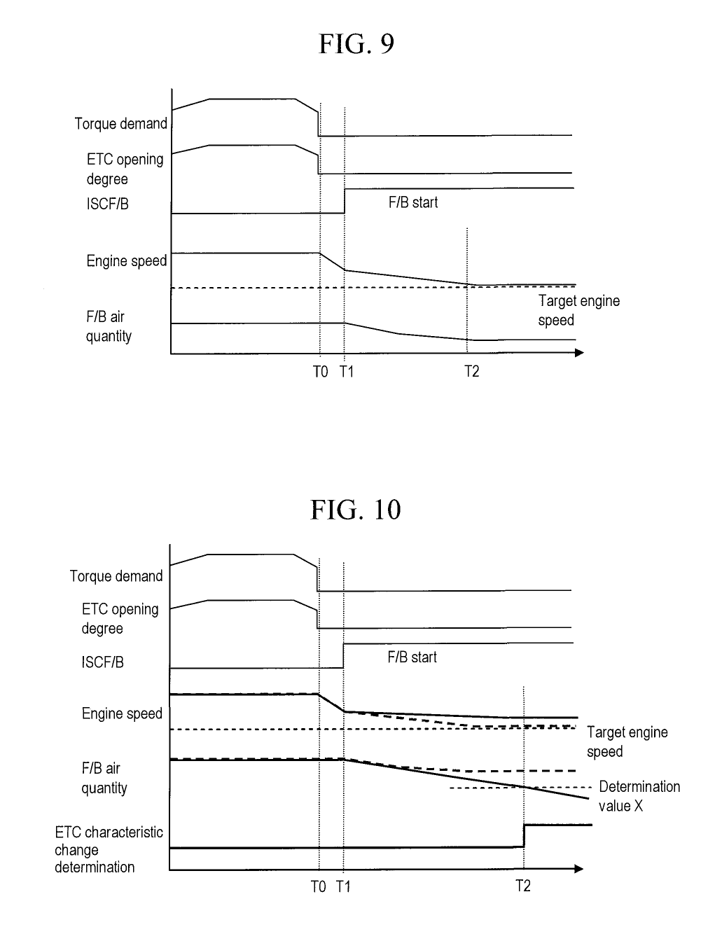

FIG. 9 is a chart showing the engine speed behavior and the change in ISC F/B air quantity in the idle state before the transition to the idle stop at the time of the deposit adhesion. At a time T0, when the torque demand to the engine is finished, the valve opening degree of the ETC is accordingly controlled to be an ISC control air quantity correspondence opening degree. Along with this closing control for the ETC opening degree, the engine speed starts to decrease at a decrease rate according to an engine friction.

After that, at a time T1, the ISC F/B control is started in order to control the engine speed in the idle operation to a desired target engine speed. After the start of the ISC F/B control, the F/B control is performed in accordance with a deviation between the target engine speed and the actual engine speed. That is, when the actual engine speed is higher than the target engine speed, the F/B air quantity is reduced, and conversely, when the actual engine speed is lower than the target engine speed, the F/B air quantity is increased.

After that, at a time T2, the deviation between the target engine speed and the actual engine speed falls within a desired deviation by the F/B control. When the ETC characteristic is drifted from its initial characteristic by the deposit adhesion or the like in the vicinity of the ETC (the ETC characteristic is deviated) and the ETC is in the clogged state, the actual air quantity is insufficient for the target valve opening degree of the ETC. For this reason, the target engine speed in the idle operation is realized by an operation of increasing the ISC F/B air quantity.

After the ETC characteristic deviation is corrected by the air quantity learning, the F/B air quantity increases and decreases within a predetermined operation amount range. That is, if the air quantity learning value matches with the actual ETC characteristic, the ISC F/B air quantity remains within the predetermined range.

FIG. 10 is a chart showing the engine speed behavior and the change in ISC F/B air quantity in the idle state before the transition to the idle stop, in the case where the deposit peeling-off has occurred at a given time point during the engine operation. As shown in FIG. 10, when the ISC F/B control is started, similarly to the above description, the ETC is controlled in a direction in which the ISC F/B air quantity decreases in order to make the actual engine speed match with the target engine speed. However, because the ETC characteristic itself has changed (has suddenly changed) due to the deposit peeling-off, the correction amount of the ISC F/B air quantity alone cannot absorb the ETC characteristic change amount, so that the actual engine speed do not match with the target engine speed.

Therefore, when the actual engine speed is higher than the target engine speed in spite of the state where the ISC F/B air quantity is reduced by a predetermined quantity or more (the F/B air quantity is reduced to be smaller than the determination value X), it is determined that the deposit peeling-off has occurred, that is, the air quantity learning value is in an unmatched state. That is, when the feedback correction air flow rate is equal to or smaller than the determination value X, it is determined that the ETC characteristic has suddenly changed (that is, the characteristic of the air flow rate with respect to the valve opening degree of the electronic throttle control valve has largely changed to the extent which is not possible compared with the previous change). The execution of the air quantity relearning is demanded in response to this determination result, to thereby timely detect the ETC characteristic change due to the deposit peeling-off or the like for performing the air quantity learning.

In addition, the determination may be made on the basis of an operation amount of the ISC F/B air quantities in not only the current idle state but also a plurality of idle states before the transition to the idle stop. That is, when the feedback correction air flow rate is equal to or smaller than the determination value X, a peeling-off state of a foreign matter (deposit peeling-off) in the vicinity of the electronic throttle control valve is determined. When the peeling-off state is continuously determined a predetermined number of times or more in the plurality of idle states before the transition to the idle stop, it may be determined that the characteristic of the air flow rate has changed.

Here, a threshold value of the ISC F/B air quantity used for the determination is not limitatively set to a fixed value from a value obtained by summing up F/B air quantity changes which are assumed in the normal state, and as shown in FIG. 11 and FIG. 12, an ETC characteristic change determination region may be calculated on the basis of a plurality of past F/B air quantities. That is, the history of the feedback correction air quantity calculated for each automatic stop control is stored, and the stored history of the past feedback correction air quantities and the current feedback correction air flow rate are compared with each other, whereby it may be determined that the ETC characteristic has changed (has suddenly changed). Further, the peeling-off state of a foreign matter in the vicinity of the electronic throttle control valve is determined on the basis of the comparison result. When the peeling-off state is continuously determined a predetermined number of times or more in the plurality of idle states before the transition to the idle stop, it may be determined that the characteristic of the air flow rate has changed.

FIG. 11 shows an example of the idle stop operation during turn-on of an ignition switch (during TRIP). If the transition to the idle stop state is noticed in advance according to the presence or absence of the torque demanded of the engine, though for a short period of time, the engine experiences the idle operation state, and then makes the transition to the idle stop state. If the torque demand is issued again, the engine is started, and the transition to the idle stop state is repeatedly performed similarly according to the presence or absence of the torque demand or the like.

Here, the idle speed control using the ISC F/B described above is executed in each of intervals A, B, and C in FIG. 11, and hence the ISC F/B air quantity used for making the actual engine speed match with the target engine speed is operated in each interval.

FIG. 12 shows an example of storage of the ISC F/B air quantity and calculation of the characteristic change determination region at a predetermined timing in each interval. The history of respective ISC F/B air quantities at a predetermined timing at this time N, the last time N-1, the time N-2 before the last . . . in which the ISC F/B is executed is stored, and the F/B air quantity in the normal state (the state where the ETC characteristic has not changed) is calculated on the basis of the history of the operation range of the F/B air quantities experienced in the past. When the ISC F/B air quantity in the idle operation exceeds the calculated F/B air quantity in the normal state, it may be determined that the ETC characteristic change (the sudden change in characteristic) has occurred.

In FIG. 12, the range of the F/B air quantity in the normal state is calculated on the basis of upper and lower limit values of the ISC F/B air quantities experienced in the past, and alternatively may be calculated on the basis of an average value+a predetermined deviation, the previous F/B air quantity+a predetermined deviation, and the like. In addition, in order to improve the calculation accuracy of the F/B air quantity in the normal state, the threshold value used for the determination may be decided by being limited to the ISC F/B air quantity in a predetermined water temperature region, for reducing an influence of an engine friction change amount.

### Second Embodiment

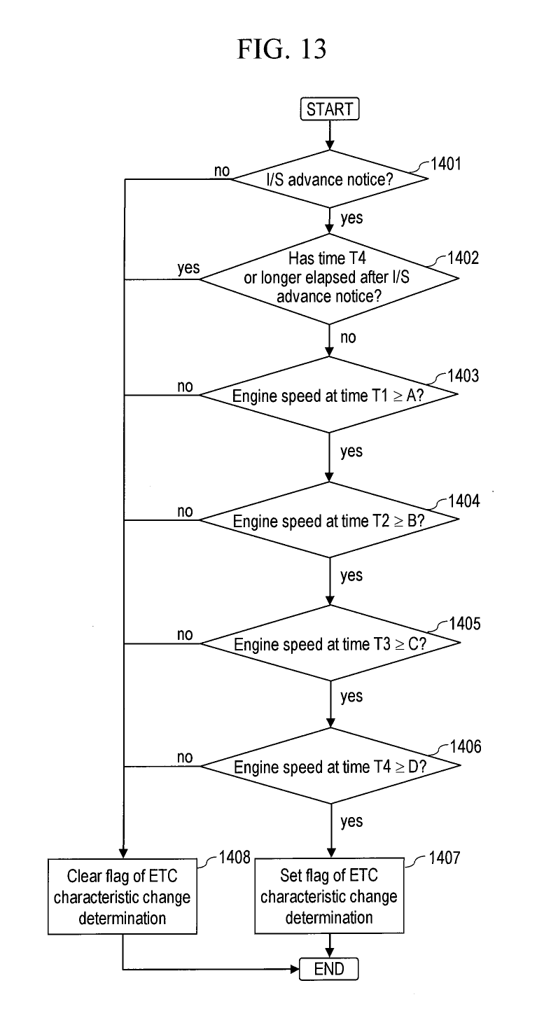

FIG. 13 is a flow chart of air quantity learning means according to a second embodiment of the present invention. As shown in FIG. 13, in the second embodiment, a speed parameter concerning the engine speed (the engine speed trace which decreases along with the change in time) is used to determine whether or not the air quantity learning is performed.

Specifically, first, in Step 1401, it is determined whether or not the idle stop control (automatic stop control) is started (there is an I/S advance notice). If the idle stop control (automatic stop control) is started in this step, the processing proceeds to Step 1402, and it is determined whether or not a time T4 or longer has elapsed after the I/S advance notice. If the time T4 or longer has not elapsed in this step, the processing sequentially proceeds to Step 1403, and it is determined whether or not the engine speed at a time T1 is equal to or higher than A. If this determination condition is satisfied, the processing proceeds to Step 1404, and it is determined whether or not the engine speed at a time T2 is equal to or higher than B. The similar determinations are made until Step 1406. If the engine speeds at all of the times T1 to T4 are equal to or higher than A to D, respectively, the processing proceeds to Step 1407, it is understood that the change in ETC characteristic such as the deposit peeling-off has occurred, a flag of the ETC characteristic change is set, and the air quantity relearning is performed. In this way, the sudden change in engine speed (the change which is not possible compared with the previous change) is determined on the basis of the engine speed trace which decreases along with the change in time (the comparison between the engine speed at each time point and its threshold value). This makes it possible to determine the sudden change in ETC characteristic (air flow rate characteristic) and use this sudden change as a trigger to perform the ETC characteristic relearning. It should be noted that, in the case of the deposit peeling-off, it is determined that the characteristic of the air flow rate has changed in the direction in which the air flow rate increases with respect to the valve opening degree.

On the other hand, if the I/S control is not started, if the time T4 or longer has elapsed after the VS advance notice, or if the engine speed at each time point is lower than the predetermined values A to D, the processing proceeds to Step 1408, the flag of the ETC characteristic change is cleared, and the air quantity relearning is not performed.

Here, it is desirable to set A to D which are the threshold values of the engine speed on the basis of an average value or a maximum value of the engine speed in the history of the past engine speeds until then. In addition, here, when the engine speeds at all of the four time points of the times T1 to T4 are equal to or higher than the corresponding predetermined values, the deposit peeling-off is determined. Alternatively, this determination may be made using only some of the four time points, the number of time points is not limited to four, and this determination may be made using a larger number of time points. As another mode, instead of using the engine speed trace which decreases along with the change in time as the history of the engine speed parameter, the change (sudden change) in ETC characteristic may be determined similarly using the engine speed and the decrease rate of the engine speed.

In this way, the stored history of the engine speed parameter and the present engine speed parameter are compared with each other, to thereby determine the change (sudden change) in ETC characteristic. Further, in the case of determining the change (sudden change) in ETC characteristic, the peeling-off state of a foreign matter in the vicinity of the electronic throttle control valve is determined on the basis of the comparison result. When the peeling-off state is continuously determined a predetermined number of times or more, it may be determined that the ETC characteristic has changed. This makes it possible to improve the determination accuracy and to learn the ETC characteristic with higher accuracy.

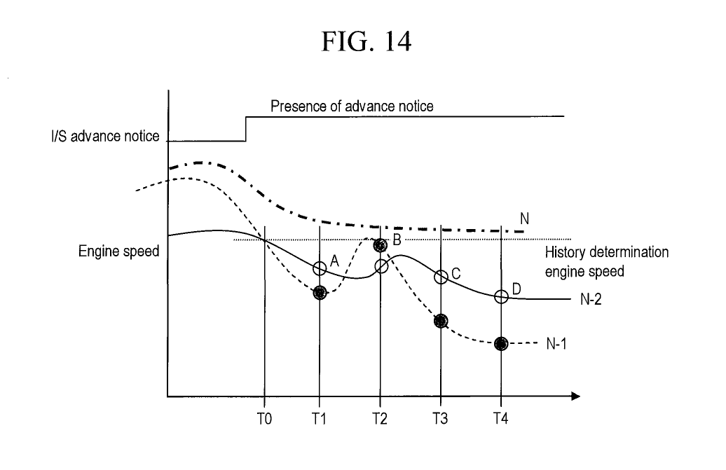

FIG. 14 is a time chart of the ETC characteristic change determination based on the engine speed behavior before the transition to the idle stop with the use of the air quantity learning means shown in FIG. 13 according to the second embodiment.

Here, after the idle stop advance notice, the engine speed starts to decrease in accordance with the engine friction, and the trace history of the actual engine speeds at the predetermined time-elapsed time points (T1, T2, T3, and T4) is stored with a time point at which the engine speed decreases to a predetermined speed being as a reference point (T0). The engine speed decrease trace in the normal state (the state where the ETC characteristic has not changed) is obtained on the basis of values of the actual engine speeds at the last time N-1 and the time N-2 before the last.

In contrast, if the deposit peeling-off occurs at this time N, the engine speed changes in an engine racing direction, and thus makes the transition at the speed higher than the stored engine speed decrease trace.

As described above, when the trace of this time has a behavior corresponding to the ETC characteristic change, in comparison with the past engine speed decrease trace (at all or some of points A, B, C, and D), it is determined that the change in characteristic (the sudden change in ETC characteristic) has occurred, and the air quantity relearning is demanded similarly to the determination using the ISC F/B air quantity described above, which makes it possible to realize timely learning execution.

In this example, the trace of this time is compared with the past experience value. Alternatively, the determination may be made using not only the trace of this time but also the engine speed trace of the subsequent time. In addition, at the time of the deposit peeling-off, the engine speed changes in the engine racing direction, and hence the engine speed decrease rate is calculated after the idle stop transition advance notice, and the determination may be made by comparing the calculated decrease rate with the engine speed decrease rate experienced in the past. Moreover, on the basis of whether or not the state where the engine speed before the transition to the idle stop is higher than a predetermined speed continues, it may be simply determined that the ETC characteristic change has occurred.

As described above, the above-mentioned two embodiments utilize the fact that, though for a short period of time, before the transition to the idle stop state, that is, the engine stop state, the idle operation state exists due to initial state returns of various engine devices, enhancing the emission quality performance, and the like. Further, according to the two embodiments, on the basis of the actual engine speed behavior and the engine speed control parameter (feedback correction air quantity) before the transition to the idle stop state, it is determined whether or not the ETC characteristic change has occurred, and the air quantity learning execution is timely demanded. Accordingly, it is possible to reduce the possibility of the operation with the air quantity learning value deviating from the actual ETC characteristic, avoid the excessive racing of the engine and the deterioration in torque realizing accuracy thereof due to excessive correction of the air quantity, and thus improve the fuel consumption performance, the emission quality performance, and the driving performance. Moreover, the two embodiments are effectively applied to a vehicle with an idle stop function, particularly, a hybrid vehicle.

What is claimed is:

1. An engine control unit which performs automatic stop control and automatic starting control of an engine and includes: an electronic throttle control valve which controls an air flow rate sucked into the engine; air flow rate detection means which detects the sucked air flow rate; and engine speed detection means which detects a speed of the engine, the engine control unit comprising:
characteristic storage means which stores therein a characteristic of the air flow rate with respect to a valve opening degree of the electronic throttle control valve;
characteristic change determination means which determines at a time of the automatic stop control that the characteristic of the air flow rate has changed in a direction in which the air flow rate increases with respect to the valve opening degree;
characteristic learning means which learns the characteristic of the air flow rate by correcting the characteristic of the air flow rate on the basis of a result of the determination; and
electronic throttle control valve control means which controls the valve opening degree of the electronic throttle control valve by using the learned characteristic of the air flow rate so that the detected air flow rate becomes a target air flow rate.

2. The engine control unit according to claim 1, further comprising feedback correction air flow rate calculation means which calculates, at a time of an idle operation in the automatic stop control, the target air flow rate so that the detected engine speed becomes a target engine speed in the idle operation, and calculates a difference between the target air flow rate and the detected air flow rate as a feedback correction air flow rate, wherein
the characteristic change determination means determines the change in the characteristic of the air flow rate on the basis of the feedback correction air flow rate.

3. The engine control unit according to claim 2, wherein the characteristic change determination means determines, when the feedback correction air flow rate is equal to or smaller than a predetermined value, that the characteristic of the air flow rate has changed.

4. The engine control unit according to claim 1, wherein:
the automatic stop control of the engine is idle stop control; and
the characteristic change determination means determines the change in the characteristic of the air flow rate in an idle operation state before the engine makes a transition to an idle stop state.

5. The engine control unit according to claim 1, wherein the characteristic change determination means determines the change in the characteristic of the air flow rate on the basis of at least one of engine speed parameters including the engine speed, an engine speed trace which decreases along with a change in time, and a decrease rate of the engine speed.

6. The engine control unit according to claim 5, wherein:
the automatic stop control of the engine is idle stop control; and
the characteristic change determination means determines the change in the characteristic of the air flow rate on the basis of the engine speed parameters before the engine makes a transition to an idle stop state.

7. The engine control unit according to claim 2, further comprising history storage means which stores therein a history of the feedback correction air quantity which is calculated for each automatic stop control of the engine, wherein
the characteristic change determination means compares the history of the feedback correction air quantity and a current feedback correction air flow rate with each other, to thereby determine the change in the characteristic of the air flow rate.

8. The engine control unit according to claim 5, further comprising history storage means which stores therein a history of at least one of the engine speed parameters including the engine speed, the engine speed trace which decreases along with the change in time, and the decrease rate of the engine speed, for each automatic stop control of the engine, wherein
the characteristic change determination means compares the stored history of the engine speed parameters and a current engine speed parameter with each other, to thereby determine the change in the characteristic of the air flow rate.

9. The engine control unit according to claim 7, wherein the characteristic change determination means determines peeling-off of a foreign matter in a vicinity of the electronic throttle control valve on the basis of a result of the comparison, and determines, when the peeling-off is continuously determined a predetermined number of times or more, that the characteristic of the air flow rate has changed.

10. An engine control unit which performs automatic stop control and automatic starting control of an engine and includes: an electronic throttle control valve which controls an air flow rate sucked into the engine; air flow rate detection means which detects the sucked air flow rate; and engine speed detection means which detects a speed of the engine, the engine control unit comprising:
characteristic storage means which stores therein a characteristic of the air flow rate with respect to a valve opening degree of the electronic throttle control valve;
characteristic change determination means which determines at a time of the automatic stop control that the characteristic of the air flow rate has suddenly changed;
characteristic learning means which learns the characteristic of the air flow rate by correcting the characteristic of the air flow rate on the basis of a result of the determination; and
electronic throttle control valve control means which controls the valve opening degree of the electronic throttle control valve by using the learned characteristic of the air flow rate so that the detected air flow rate becomes a target air flow rate.

11. The engine control unit according to claim 10, further comprising feedback correction air flow rate calculation means which calculates, at a time of an idle operation in the automatic stop control, the target air flow rate so that the detected engine speed becomes a target engine speed in the idle operation, and calculates a difference between the target air flow rate and the detected air flow rate as a feedback correction air flow rate, wherein
the characteristic change determination means determines the sudden change in the characteristic of the air flow rate on the basis of the feedback correction air flow rate.

12. The engine control unit according to claim 11, wherein the characteristic change determination means determines, when the feedback correction air flow rate is equal to or smaller than a predetermined value, that the characteristic of the air flow rate has suddenly changed.

13. The engine control unit according to claim 10, wherein the characteristic change determination means determines the sudden change in the characteristic of the air flow rate on the basis of at least one of engine speed parameters including the engine speed, an engine speed trace which decreases along with a change in time, and a decrease rate of the engine speed.

14. The engine control unit according to claim 11, further comprising history storage means which stores therein a history of the feedback correction air quantity which is calculated for each automatic stop control of the engine, wherein
the characteristic change determination means compares the history of the feedback correction air quantity and a current feedback correction air flow rate with each other, to thereby determine the sudden change in the characteristic of the air flow rate.

15. The engine control unit according to claim 13, further comprising history storage means which stores therein a history of at least one of the engine speed parameters including the engine speed, the engine speed trace which decreases along with the change in time, and the decrease rate of the engine speed, for each automatic stop control of the engine, wherein
the characteristic change determination means compares the stored history of the engine speed parameters and a current engine speed parameter with each other, to thereby determine the sudden change in the characteristic of the air flow rate.
